(19) United States
(12) Patent Application Publication
(10) Pub. No.: US 2019/0243147 A1
(43) Pub. Date: Aug. 8, 2019

(54) POLARIZATION-SENSITIVE PANCAKE OPTICS

(71) Applicant: Disney Enterprises, Inc., Burbank, CA (US)

(72) Inventors: Quinn Yorklun Jen SMITHWICK, Pasadena, CA (US); Eric C. HASELTINE, Silver Spring, MD (US)

(21) Appl. No.: 15/891,203

(22) Filed: Feb. 7, 2018

(51) Int. Cl. G02B 27/10; G02B 27/28; G02B 27/01; G02B 5/30; G02B 5/02

(52) U.S. Cl. CPC G02B 27/10; G02B 27/283; G02B 2027/0123; G02B 5/3025; G02B 5/0294; G02B 27/0103

(57) ABSTRACT

Implementations of augmented reality (AR)/virtual reality (VR) display devices with optical arrangements that are compact and brighter than traditional pancake optics are disclosed herein. One embodiment provides a display device in which the traditional pancake optics' concave 50/50 beam splitter mirror element is replaced with a linearly polarization-selective mirror element, producing four times the brightness of traditional pancake optics while being approximately half as thick as a simple magnifier. In another embodiment, a display device includes both the concave linearly polarization-selective mirror element and a circularly polarization-selective mirror element, producing even brighter output. In a further embodiment, a display device includes a flat (rather than concave) linearly polarization-selective mirror element and one or more additional lens elements that collimate light, which may reduce aberrations and/or thickness. In yet another embodiment, the arrangement of optical elements is “flipped” such that the polarization-selective mirror element is flat and relatively easier to manufacturer.

### BACKGROUND

### Field

The present disclosure generally relates to computer-based entertainment, and more specifically to optical arrangements suitable for augmented reality (AR) and/or virtual reality (VR) display devices.

### Description of the Related Art

Computer graphics technology has significantly progressed since the first video games were developed. Relatively inexpensive 3D graphics engines can now produce nearly photo-realistic interactive virtual environments. Virtual reality (VR) in particular involves generating images, sounds, etc. that simulate a user's presence in a virtual environment, typically using specialized equipment such as VR headsets. In contrast, augmented reality (AR) involves superimposing computer generated imagery on a user's view of the real-world environment.

VR/AR head-mounted displays, as well as other types of displays such as those of flight simulators, can require a wide field of view and high resolution with a large eyebox. A simple magnifier, such as that shown in FIG. 1, is one approach for making a wide field of view, high-resolution display with a large eyebox. As shown in FIG. 1, a display device 100 with a simple magnifier typically includes a display 110 disposed at a focal plane of a lens element 120 that collimates light emitted by the display 110, making the displayed imagery appear to be “at infinity,” or very far away. The longer the focal length of the lens element 120, the larger the eyebox, making for easier eye alignment. However, a display device with such a lens is also longer and larger, which can be undesirable. For example, the length/size of a head-mounted display with a simple magnifier creates a moment pulling the head-mounted display downward, which is not comfortable for the wearer and can create eye alignment problems. Such a moment can be counter balanced, but adding a counter balance also adds to the weight of the head-mounted device on the user's head.

FIG. 2 illustrates a display device 200 with traditional “pancake” optics (lenses), which have been used to fold the inline path of the simple concave mirror magnifier to produce a shorter optical arrangement. As shown in panel A, the display device 200 includes a display 210 and an arrangement of optical elements including a linear polarizer element 220, a concave 50/50 beam splitter (half-silvered) mirror element 230, a quarter-wave plate element 240 (also sometimes referred to a “quarter-wave retarder”), a flat 50/50 (half-silvered) beam splitter element 250, and a circular polarizer element 260. The display 210 may be any type of display capable of generating imagery, such as a liquid crystal display (LCD), an organic light emitting diode (OLED) display, or the like. It should be understood that light emitted from LCD displays is typically linearly polarized, while light emitted from OLED displays is typically not linearly polarized. If the light from the display device 200 is already linearly polarized, then the linear polarizer element 220 may be omitted.

Light emitted by the display 210 passes through the optical arrangement of the display device 200, sometimes referred to as pancake optics, which as described folds the inline path that light would take in a simple magnifier. As a result, the distance between the display 210 and the output circular polarizer element 260 can be reduced to half the focal length of the concave beam splitter element 230, thereby reducing the depth and moment of the display device 200. Illustratively, a light 215 from display device 200 passes back and forth through the optical arrangement before being collimated by the concave beam splitter element 230 acting as a collimating mirror, and then the collimated light passes through the optical arrangement once more before exiting the display device 200. Unfortunately, experience has shown that light produced by pancake optics devices such as the display device 200 tends to be very dim. As discussed in greater detail below, each time the folded light pass interacts with the concave beam splitter element 230 and the flat beam splitter element 250, half the light is discarded by that beam splitter. Assuming light emitted by the display 210 is not already polarized, the initial polarizer element 220 that is used to polarize the light also reduces the amount of light by half. As light passing through the optical arrangement interacts with the initial polarizer element 220 once and the concave and flat beam splitter elements 230 and 250 a total of four times, only 1/32 of the light initially emitted by the display 210 ultimately exits the display device 200 (or 1/16 if light from the display 210 is pre-polarized and the linear polarizer element 220 is not used).

Panel B illustrates in greater detail light polarizations and throughput in the display device 200. As shown, the light 215 emitted by the display 210 first passes through the linear polarizer element 220, which linearly polarizes the light 215. That is, the linear polarizer element 220 allows light of one linear polarization (either horizontal or vertically polarized light) to pass, while discarding light of the other linear polarization. Doing so reduces the amount of the light 215 by approximately half. The linearly polarized light is incident on the concave beam splitter element 230, which transmits half of the light and reflects the other half of the light with a 90 degree rotated polarization that is orthogonal to that of the incident light. Approximately 25% of the light 215 originally emitted by the display 210 passes through the concave beam splitter element 230. The light from the concave beam splitter element 230 then passes through the quarter-wave plate element 240, which converts the linearly polarized light to circularly polarized light. The circularly polarized light is incident upon the flat beam splitter element 250, which transmits half of the light and reflects the other half, with orthogonal circular polarization (shown as circular left, as opposed to circular right polarized light that is transmitted). Approximately 12.5% of the light 215 originally emitted by the display 210 is reflected by the flat beam splitter element 250. The reflected, circularly polarized light from the flat beam splitter element 250 passes through the quarter-wave plate element 240 again, which converts the circularly polarized light back into linearly polarized light, with an orthogonal polarization to the light previously transmitted by the concave beam splitter element 230. The linearly polarized light is then incident upon the concave beam splitter element 230, which collimates the light and reflects half of the linearly polarized light with a 180 degree rotation while transmitting half of the light with the orthogonal polarization. Approximately 6.25% of the light 215 originally emitted by the display 210 is reflected by the concave beam splitter element 230. The light reflected by the concave beam splitter element 230 passes through the quarter-wave plate element 240 again, which circularly polarizes the light. The circularly polarized light is then incident upon the flat beam splitter element 250, which again transmits half of the light and reflects another half with an orthogonal circular polarization (shown as circular right, as opposed to circular left polarized light that is transmitted). Approximately 3.125% of the light 215 originally emitted by the display 210 is transmitted by the flat beam splitter element 250. The circularly polarized light that is transmitted by the flat beam splitter element 250 further passes through the circular polarizer element 260, which transmits the circularly polarized light that then exits the display device 200. Although approximately 3.125% of the original light 215 from the display 210 is shown as exiting the display device 200, the light throughput may be approximately 6.25% if light emitted by the display 210 is already linearly polarized, such as the linearly polarized light emitted by polarized LCDs, in which case the initial polarizer element 220 may transmit 100% of such linearly polarized light from the display 210 or be omitted entirely.

### SUMMARY

One embodiment of this disclosure provides a display device. The display device generally includes a display configured to emit light and an optical arrangement. The optical arrangement includes a first beam splitter mirror element that is linearly polarization-selective and configured to transmit a portion of the emitted light as a first linearly polarized light. The optical arrangement further includes a quarter-wave plate element configured to convert the first linearly polarized light into a first circularly polarized light. In addition, the optical arrangement includes a second beam splitter mirror element configured to reflect, toward the quarter-wave plate element, a first portion of the first circularly polarized light. The quarter-wave plate converts the reflected first portion of the first circularly polarized light into a second linearly polarized light. The first beam splitter mirror element reflects, toward the quarter-wave plate element, the second linearly polarized light with a 180 degree rotation as a third linearly polarized light. The quarter-wave plate element converts the third linearly polarized light into a second circularly polarized light. The second beam splitter mirror element transmits a portion of the second circularly polarized light.

Another embodiment of this disclosure provides a display device. The display device includes a display configured to emit light and an optical arrangement. The optical arrangement includes a circular polarizer element configured to transmit a portion of the emitted light as a first circularly polarized light. The optical arrangement further includes a concave first beam splitter mirror element configured to transmit a portion of the first circularly polarized light. The optical arrangement also includes a quarter-wave plate element configured to convert the portion of the polarized light transmitted by the first beam splitter into a first linearly polarized light. In addition, the optical arrangement includes a flat second beam splitter mirror element, the second beam splitter mirror element being linearly polarization-selective and configured to reflect, toward the quarter-wave plate element, the first linearly polarized light. The quarter-wave plate element converts the reflected first linearly polarized light into a second circularly polarized light. The first beam splitter mirror element reflects, toward the quarter-wave plate element, the second circularly polarized light with an orthogonal polarization as a third circularly polarized light. The quarter-wave plate element converts the third circularly polarized light into a second linearly polarized light. The second beam splitter mirror element transmits the second linearly polarized light.

Another embodiment of this disclosure provides a display device. The display device includes a display and a linearly polarization-selective beam splitter mirror element. The display device further includes a quarter-wave plate element and at least one of a half-silvered beam splitter mirror element and a circularly polarization-selective mirror element.

Other embodiments include, without limitation, a computer-readable medium that includes instructions that enable a processing unit to implement one or more embodiments of the disclosed method, as well as a system configured to implement one or more aspects of the disclosed method.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates a display device with a simple magnifier optical arrangement.

FIG. 2 illustrates a display device with traditional pancake optics.

FIG. 3 illustrates an example interactive environment that includes a display device with modified pancake optics, according to an embodiment.

FIGS. 4-11 illustrate example implementations of display devices with modified pancake optics, according to various embodiments.

### DETAILED DESCRIPTION

Various embodiments of augmented reality (AR)/virtual reality (VR) display devices with optical arrangements that are compact and brighter than traditional pancake optics are disclosed herein. One embodiment provides a display device in which the traditional pancake optics' concave 50/50 beam splitter (half-silvered) mirror element is replaced with a linearly polarization-selective mirror element, producing four times the brightness of traditional pancake optics while being approximately half as thick as the simple magnifier. In another embodiment, a display device includes both the concave linearly polarization-selective mirror element and a circularly polarization-selective mirror element, producing even brighter output. In another embodiment, a display device includes a flat (as opposed to concave) linearly polarization-selective mirror element and one or more additional lens elements that collimate light, which may reduce aberrations and/or the thickness of the device. In another embodiment, a display device includes a linearly polarization-selective mirror element and a circularly polarization-selective mirror beam splitter element that are both curved in a “clamshell” configuration, which may increase optical performance and be relatively easier/cheaper to manufacture. In another embodiment, a display device includes a concave linearly polarization-selective mirror element that fills the entire optical arrangement stack's thickness, producing a wider field of view. In another embodiment, a display device includes an arrangement of optical elements that is “flipped” such that the polarization-selective mirror element is flat, which is relatively easier to manufacturer than a curved polarization-selective mirror element. In another embodiment, a display device includes a canted optical arrangement, allowing for a wider field of view. In yet another embodiment, a display device includes an optical arrangement, such as one with multiple flat mirror elements that can be switched on and off with different spacings from a concave lens, which permits a focal plane to be changed in real time based on where displayed imagery is or the creation of a light field.

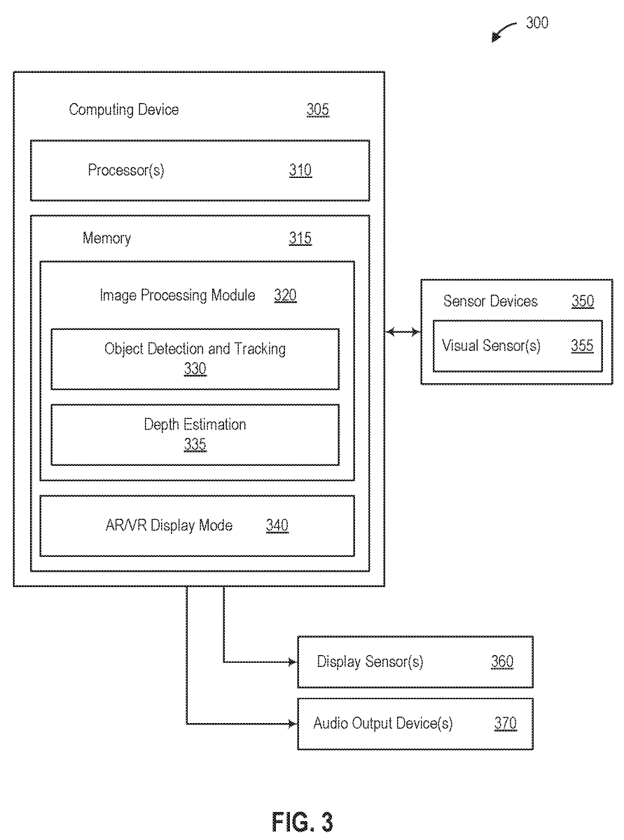

FIG. 3 illustrates an example interactive environment that includes a display device with modified pancake optics, according to an embodiment. Within a system 300, a computing device 305 communicates with one or more sensor devices 350, one or more display devices 360, and one or more audio output devices 370. As will be discussed in greater detail below, the computing device 305 may provide an augmented reality (AR) and/or virtual reality (VR) display functionality for a user in the interactive environment. The computing device 305 may be embodied in any suitable form. For example, the computing device 305 may be a body-worn computing device, e.g., integrated into an assembly worn on the head, arm, etc. of a user. As another example, the computing device 305 may be a mobile computing device, such as a smartphone, tablet, etc. that can be physically and removably attach with a body-worn assembly.

As shown, the computing device 305 includes a processor 310 and memory 315. The processor 310 generally retrieves and executes programming instructions stored in the memory 315. The processor 310 is included to be representative of a single central processing unit (CPU), multiple CPUs, a single CPU having multiple processing cores, and/or graphics processing units (GPUs) having multiple execution paths, and the like. The memory 315 is generally included to be representative of a random access memory, but may further include non-volatile storage of any suitable type(s).

The sensor devices 350 may be of any suitable type(s) and configured to sense information regarding the physical environment. Some examples of sensor devices 350 include visual sensors 355, pressure sensors, acceleration sensors, and temperature sensors. The visual sensors 355 may include cameras configured to sense visible light and/or infrared light. In some embodiments, the sensor devices 350 may be included with (or within) the computing device 305. For example, where the computing device 305 is a smartphone or tablet device, the sensor devices 350 may include camera(s), inertial motion units (IMUs), etc. within the smartphone/tablet device. In some embodiments, the sensor devices 350 includes sensor(s) that are external to the computing device 305, such as a visual sensor within a head-worn device.

The memory 315 further includes an image processing module 320 configured to perform processing of visual information captured by visual sensors 355. The image processing module 320 may include any number of image processing functions, such as an object detection and tracking sub-module 330 configured to detect physical objects within the interactive environment (e.g., based on edge detection information, color information, and/or other suitable features) and to track the relative location of detected objects over time (e.g., as a user and/or the objects move throughout the interactive environment). As shown, the image processing module 320 further includes a depth estimation sub-module 335 configured to dynamically estimate distances of the detected objects from the user.

The system 300 also includes one or more display devices 360, and one or more audio output devices 370. The display devices 360 may include visual displays of any suitable type. In some embodiments, the display devices 360 may be included within the computing device 305 (e.g., a main display screen of the smartphone, tablet device, etc.). In other embodiments, the display devices 360 may be separate from the computing device 305. The display devices 360 may each be any type of dynamic display capable of displaying a visual interface to a user, and each of the display devices 360 may include any type of light emitting diode (LED), organic LED (OLED), cathode ray tube (CRT), liquid crystal display (LCD), plasma, electroluminescence (EL), or other display technology, as well an arrangement of optical elements that provides increased brightness of the displayed image relative to traditional pancake optics and that may also be smaller in size than traditional pancake optics, as discussed in greater detail below. Although discussed primarily with respect to display devices that are head-mounted displays, it should be understood that optical arrangements disclosed herein may generally be beneficial in, e.g., any applications where thickness of a display device is constrained and a wide field of view and brightness are required or desired. For example, optical arrangements disclosed herein may be included in flight simulators, wall or car-mounted display devices, and multi-person display devices (e.g., a porthole in a submarine that includes a display), among other things.

The optical arrangements in the display devices 360 are configured to transmit some or all of the light emitted by an LED, OLED, CRT, LCD, plasma, EL, or other display to the user's eyes. Depending on the currently selected mode (AR or VR), the optical arrangement is further configured to transmit some or all of the light from the physical environment to the user's eyes. It should be understood that it is generally beneficial to design an AR/VR display to be brighter and have a relatively small size and weight. Brighter displays may be relatively easier and more pleasant to view. At the same time, smaller and lighter body-worn displays allow for use by younger users or other users with reduced size and/or strength, by reducing the moment pulling the AR/VR display down that may otherwise produce user discomfort and eye alignment problems. A compact design may also reduce manufacturing costs through reduced material and process requirements, as well as be more aesthetically pleasing compared to a large or bulky design.

In the case of AR, the display devices 360 may be configured to superimpose virtual imagery onto physical objects in the user's field of view. For example, the display devices 360 may be integrated into a body-worn device such as a headset, and the display devices 360 may be configured as an eyepiece or lens worn in front of the user's eye. In another example, the display devices 360 may be integrated into other devices that are carried or handled by the user, or have any other suitable user interaction. For example, the user may carry a toy blaster that includes an optical sight for aiming, and the display devices 370 may be integrated in the optical sight.

The audio output devices 370 may include conventional audio speakers having any suitable form factor (e.g., standalone, integrated in a stereo, headphones, etc.), as well as devices using alternative methods of producing sound perceptible by a user, such as bone conduction transducers in a body-worn device. In some embodiments, the audio output devices 370 may be included within the computing device 305 (e.g., speakers of the smartphone, tablet device, etc.). In other embodiments, the audio output devices 370 may be separate from the computing device 305.

In some embodiments, the computing device 305 may be configured to operate in an AR mode, in which virtual images such as characters, objects, and/or dynamic visual effects are superimposed into the user's natural field of view of the environment using the display device 360. The field of view of the user may be determined using sensor devices 350 such as the visual sensors 355. For example, the display device 360 may superimpose a virtual character to appear seated on a physical chair detected within the environment. The display of the virtual character on the display device 360 may then be dynamically adjusted based on the user's field of view (orientation), the determined depth of the chair from the user, and so forth.

In other embodiments, the computing device 305 may be configured to operate in a virtual reality (VR) mode, in which the user's natural field of view of the environment is replaced with virtual imagery using the display device 360. In yet further embodiments, the computing device 305 may be configured to dynamically select between AR and VR modes based on the sensed characteristics of the environment and/or based on a story being presented. The selection of the AR or VR mode is shown as AR/VR display mode 340 and included in memory 315. For example, the visual sensors 355 may detect that the environment is extremely bright (e.g., when the user is in direct sunlight), which may make it difficult for a user to view overlaid information using the display device 360. In another example, a virtual setting of a story being presented may specify a night-time setting. In these examples, the VR mode may be enabled in order to substantially isolate the user's field of view from the surrounding physical environment and thereby reduce the amount of light received from the environment. In both cases, dynamic selection of the AR/VR display mode 340 can improve the immersive nature of the storytelling environment, whether through ensuring the user is able to suitably view the overlaid information or through providing a more realistic setting consistent with the virtual setting of a story. Switching between AR and VR modes may be accomplished through any suitable techniques, such as (either manually or automatically) rotating one or more cross polarizers to selectively reduce light from the physical environment that is transmitted to a user's eyes and substantially isolate the user's field of view from the physical environment (e.g., a VR mode), or selectively darkening a partially or fully transparent “see-through” display, such as an OLED or side-lit or naturally lit LCD, to substantially isolate the user's field of view from the physical environment.

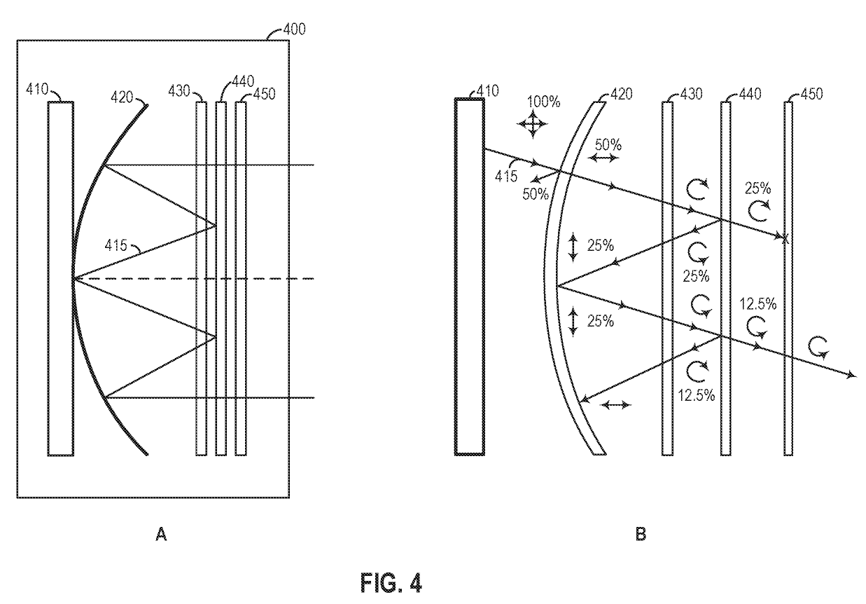

FIGS. 4-11 illustrate in greater detail one or more of the display devices 360, according to various embodiments. Although not explicitly shown in FIGS. 4-8 and 10, it should be understood that the optical arrangements of the display devices depicted in FIGS. 4-8 and 10 may in some embodiments include independent optics for each eye of a viewer. Further, in some embodiments, implementations of the display devices 400, 500, etc. may include some independent optics (e.g., one per eye) and some shared optics (e.g., one for both eyes). Although examples of specific optical elements may be discussed, it should be understood that optical elements disclosed herein may generally be manufactured from any suitable material in any feasible manner, so long as the optical elements have the properties (e.g., linear polarization selectiveness, circular polarization selectiveness, etc.) described herein. In addition, the features described with respect to a particular implementation may be beneficially applied to other implementations without requiring an explicit recitation.

FIG. 4 illustrates a display device 400 with modified pancake optics, according to a first embodiment. As shown in panel A, the display device 400 includes a display 410 and an arrangement of optical elements including a linearly polarization-selective mirror element 420, a quarter-wave plate element 430, a 50/50 (half-silvered) flat beam splitter element 440, and a circular polarizer element 450. The display 410 is similar to the display 210 of the display device 200, discussed above, and will not be described in detail herein for conciseness. Although depicted as flat for illustrative purposes, in some embodiments the display 410 may have a compound curve shape, which counteracts Petzval field curvature and may produce a better image quality with less distortion.

The optical arrangement of the display device 400 differs from that of the display device 200, as the quarter-wave plate element 430 and the flat beam splitter element 440 are both achromatic, and the linear polarizer element 220 and the concave 50/50 beam splitter (half-silvered) mirror element 230 are replaced with the linearly polarization-selective mirror element 420, which is also achromatic and is not a polarization neutral reflector like the 50/50 beam splitter mirror element 230. It should be understood that most polarizers and films are designed for one wavelength, as opposed being achromatic (also referred to as broadband) and capable of handling multiple wavelengths. For example, while a concave 50/50 beam-splitter may be achromatic because it is reflective (either using a silver coating or broadband multilayer coating), quarter-wave plates are often designed for one frequency, such as 560 nm, in which case other wavelengths will not have the correct retardance. In particular, the other wavelengths will not be completely blocked or passed by the linearly polarization-selective mirror element 420, resulting in cross-talk between the direct view of the display and the desired collimated view. As a result, such a quarter-wave plate designed for one frequency is suboptimal for color images. In one embodiment, the quarter-wave plate element 430 may instead be achromatic or broadband. An achromatic quarter-wave plate may be constructed using materials with opposite dispersions, using many layers with odd multiples of the desired retardation, and aligning the slow axis of some layers with the fast axis of other layers to achieve the desired birefringence and retardance. A broadband quarter wave retarder may also be constructed by placing a single frequency half-wave retarder at 15° with respect to linearly polarized light, and a single frequency quarter wave retarder at 75° to the half-wave retarder. Similarly, it should be understood that a circular polarizer, such as the circular polarizer element 450, is typically made using a linear polarizer with a quarter-wave plate, so a typical circular polarizer may be wavelength sensitive. In one embodiment, the circular polarizer element 450 may instead be achromatic.

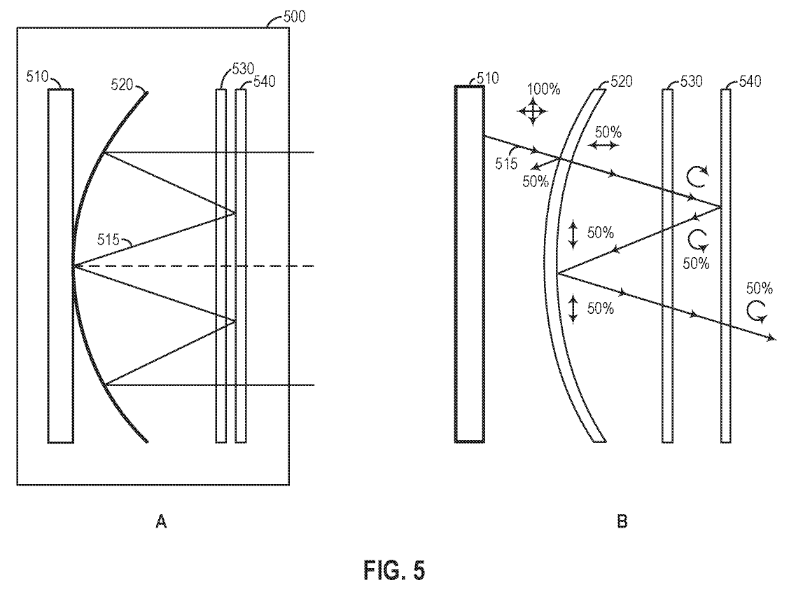

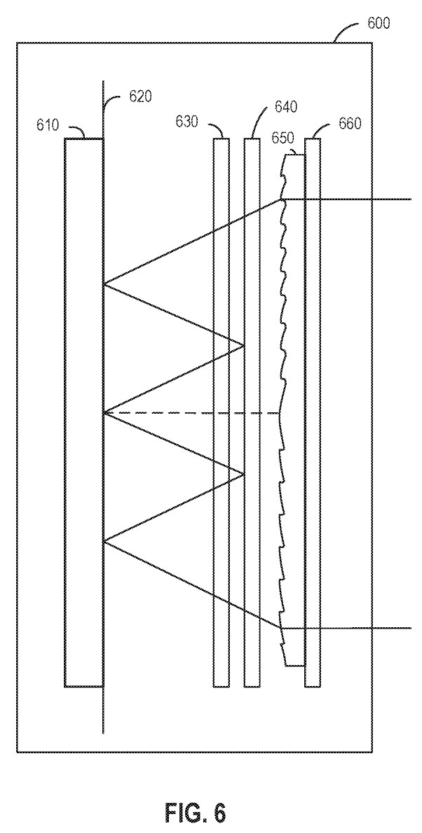

In addition to being achromatic, the circular polarizer element 450 and the quarter-wave plate element 430 may also be anti-reflection (AR) coated (e.g., CircPolarzier—double sided AR). Otherwise, reflections may be created before the linearly polarization selective mirror 420, and such unwanted reflections will be recycled in the polarization optics leading to ghosting and lower contrast. In embodiments disclosed herein, the only desired reflections are at the mirrors (e.g., at the linearly polarization-selective mirror element 420 and the 50/50 beam splitter mirror element 440 in the display device 400), not stray reflections such as those due to Fresnel reflections off of quarter-wave plates or stray reflections off of any other retarders/waveplates to convert from linear to circular polarization (or vice versa), and AR coatings may be applied on sides of such elements that should not produce reflections if those elements are not laminated to other surfaces. For example, each of the quarter-wave plates may be AR coated on a side facing the half-silvered (or dielectric) mirror. That is, the need to prevent stray reflections off non-mirror elements such as quarter-wave plates applies to the embodiments (in all of the figures) disclosed herein, such as the quarter-wave plate element 430 in FIG. 4, the quarter-wave plate element 530 in FIG. 5, the quarter-wave plate element 630 in FIG. 6, etc., which are quarter wave plates between the half-silvered (or dielectric) beam-splitter and the polarization selective mirror (linear or chiral). As described in greater detail below, depending upon the configuration, either (or both or neither) the beam-splitter or the polarization selective mirror may be concave. Although sometimes discussed herein as being next to a 50/50 curved beam-splitter and/or a polarization selective mirror, in some embodiments the quarter-wave plate, such as the quarter-wave plate element 430, may be separate (i.e., not laminated or next to) a 50/50 curved beam-splitter and/or polarization selective mirror. In addition, the quarter-wave plate may be tilted and spaced (and double sided antireflection coated) to redirect and defocus any residual reflections from its surfaces. In one embodiment, the quarter-wave plate element may be a tilted spaced double-sided AR-coated quarter-wave plate, as opposed to a quarter-wave plate placed or laminated flat to a polarization selective mirror or placed flat or laminated curved on a 50/50 mirror, to redirect and defocus undesired reflections off of the quarter-wave plate (so the undesired reflections are not recycled in the polarization optics leading to ghost images). In such a case, the achromatic polarization selective mirror and polarizers will block or pass the appropriate type of polarization, producing only a collimated magnified view and not a direct view of the display. However, light normally allowed to pass through the polarization selective mirror may be partially reflected off the quarter-wave plate between a beam-splitter and the before the polarization selective mirror. This undesired reflected light may be redirected back to the beam-splitter, with some of the light passing through the beam-splitter, and some being further focused, resulting in dim out-of-focused ghost images. Anti-reflection coatings on an initial quarter wave-plate (on the display to convert from linearly polarized light to circularly polarized light) and the quarter-wave plate between the beam splitter and the polarization selective mirror, can prevent a majority of these undesirable reflections. Furthermore, the quarter-wave plate between the beam-splitter and before the polarization selective mirror, may either be laminated to the polarization selective mirror to prevent reflections at those interfaces, or the quarter wave plate may be tilted and strategically positioned (as well as being anti-reflection coated on both sides) to redirect and defocus/diffuse any undesired reflections from the surface. It should be understood that, when tilting the quarter-wave plate, the effective wavelength of the light changes with the tilt of the wave plate, so an achromatic quarter-wave plate should be used.

Similar to the quarter-wave plate element 430 and the circular polarizer element 450, the linearly polarization-selective mirror element 420 may also be achromatic. For example, the linearly polarization-selective mirror element 420 may be a wire grid polarization selective mirror or a multilayer Bragg reflector. The achromatic linearly polarization-selective mirror element 420 acts as a concave beam splitter, but more efficiently uses light emitted by the display 410 than the linear polarizer element 220 and the 50/50 beam splitter mirror element 230, allowing the display device 400 to produce a brighter output. As discussed in greater detail below, light interacts with the polarization-selective mirror element 420 twice, preventing ¼ of the light from being lost. As a result, the display device 400 is approximately four times more light efficient than the display device 400 with traditional pancake optics, while still being about half the depth of a simple magnifier device. Approximately a quarter of the light is also lost at the flat beam splitter element 440.

In another embodiment, the display device 400 may include a high-resolution shaped coherent optical fiber bundle (not shown). Such a high-resolution shaped coherent optical fiber bundle may be utilized to make a curved object plane from the flat display 400. Similarly, other embodiments disclosed herein (in FIGS. 5-11) may also include such a high-resolution shaped coherent optical fiber bundle. It should be understood that a concave mirror will exhibit field curvature, as collimated light will focus to a curved plane rather than a flat plane, and a curved display may be used to make off-axis light collimated. As a display (e.g., the display 400) typically cannot be bent with compound curvature (to form a bowl shape), a coherent fiber bundle may be used to relay points of the display (one end of the coherent fiber bundle) to a concave surface (other end of the coherent fiber bundle).

Panel B illustrates in greater detail light polarizations and throughput in the display device 400. As shown, light 415 emitted by the display 410 first passes through the (linearly) polarization-selective mirror element 420, which transmits one orientation of linearly polarized light (e.g., vertically polarized light), while reflecting the other orthogonal linear orientation (e.g., horizontally polarized light). Any suitable type of linearly polarization-selective mirror may be used, such as a wire grid polarizer or a multilayer Bragg reflector. The linearly polarization-selective mirror may be manufactured by, e.g., laminating a linearly polarization-selective mirror to conform like a membrane to a curved surface with boundary conditions meeting a frame (i.e., be a conformal membrane), thereby creating a compound curve, or other desired shape. For example, a linearly polarization-selective mirror may be manufactured to conform to the Poisson equation. In alternative embodiments, discussed in greater detail below, the linearly polarization-selective mirror may be flat, and such mirrors may be manufactured by supporting the linearly polarization-selective mirror on its edges to make the material flat and taut. In some embodiments, edge(s) of the linearly polarization-selective mirror may be curved, or the linearly polarization-selective mirror may be tilted, to reduce aberrations including defocus and make parts of the imagery generated by the display 410 more in focus.

As shown, the one orientation of linearly polarized light (shown as horizontally polarized light) that is transmitted by the polarization-selective mirror element 420 is 50% of the light 415 originally emitted by the display 410. In alternative implementations of the optical elements disclosed herein, the polarization-selective mirror element 420 may reflect and/or transmit differing percentage ratios of light. The linearly polarized light transmitted by the polarization-selective mirror element 420 passes through the quarter-wave plate element 430, which converts the linearly polarized light to circularly polarized light. The circularly polarized light is then incident upon the flat beam splitter element 440, which transmits half of the light and reflects the other half with orthogonal circular polarization (shown as circular left, as opposed to circular right polarized light that is transmitted). 25% of the light 415 originally emitted by the display 410 is reflected by the flat beam splitter element 440. The reflected, circularly polarized light from the flat beam splitter element 440 passes through the quarter-wave plate element 430 again, which converts the circularly polarized light back into linearly polarized light, with a polarization orthogonal to the light that originally passed through the polarization-selective mirror element 420. The linearly polarized light is then incident upon the polarization-selective mirror element 420, which collimates the light, i.e., turns a point of the display imagery into collimated light that appears to be “at infinity” or very far away, and reflects the linearly polarized light with a 180 degree rotation. Unlike the concave beam splitter element 220 of the display device 200, none of the linearly polarized light is transmitted by the polarization-selective mirror element 420. The light reflected by the polarization-selective mirror element 420 passes through the quarter-wave plate element 430 again, which circularly polarizes the light. The circularly polarized light is then incident upon the flat beam splitter element 440, which again transmits one half of the light and reflects the other half with orthogonal circular polarization (shown as circular left, as opposed to circular right polarized light that is transmitted). 12.5% of the light 415 originally emitted by the display 410 is transmitted by the flat beam splitter element 440. The circularly polarized light that is transmitted by the flat beam splitter element 440 further passes through the circular polarizer element 450, which as shown transmits the (left) circularly polarized light that then exits the display device 400. Although 12.5% of the original light 415 from the display 410 is shown as exiting the display device 400, the light throughput may be 25% if light emitted by the display 410 is already linearly polarized, such as the linearly polarized light emitted by polarized LCDs, in which case the polarization-selective mirror element 420 may transmit 100% (rather than 50%) of such linearly polarized light from the display 410.

FIG. 5 illustrates a display device 500 with modified pancake optics, according to a second embodiment. As shown in panel A, the display device 500 includes a display 510 and an arrangement of optical elements including a linearly polarization-selective mirror element 520, a quarter-wave plate element 530, and a circularly polarization-selective beam-splitter element 540. The display 510, the linearly polarization-selective mirror element 520, and the quarter-wave plate element 530 are similar to the display 410, linearly polarization-selective mirror element 420, and quarter-wave plate element 430, respectively, of the display device 400, discussed above, and will not be described in detail herein for conciseness. In particular, the linearly polarization-selective mirror element 520 and the quarter-wave plate element 530 may be achromatic, and the quarter-wave plate element 530 may further be AR-coated like the quarter-wave plate element 430. The optical arrangement of the display device 500 differs from that of the display device 400 in that the flat beam splitter element 440 and the circular polarizer element 450 are replaced with the circularly polarization-selective beam-splitter element 540, which is a material that transmits one handedness of circularly polarized light (e.g., left handed polarized light) while reflecting the other (e.g., right handed polarized light) and also changing the handedness of the reflected light (e.g., from right handed polarized light to left handed polarized light). The circularly polarization-selective beam-splitter element 540 may also be achromatic in one embodiment. The circularly polarization-selective beam-splitter element 540 permits even more efficient use of light emitted by the display 510 and an even brighter output from the display device 500. In particular, the display device 500 is essentially 100% efficient if light emitted by the display 510 is linearly polarized, or approximately 50% efficient if light emitted by the display 510 is not linearly polarized, while still being about half the depth of a simple magnifier device.

It should be understood that light incident on the flat beam splitter element 440 in the display device 400 is circularly polarized due to the placement of the quarter-wave plate element 430 in the optical arrangement. The circularly polarized light switches polarization handedness when reflecting off of the flat beam splitter element 440, which makes the optics able to separate out the collimated image that is output by the display device 400 from the direct view image of the display that is extinguished by the circular polarizer element 450. A linearly polarization-selective mirror element cannot be used in lieu of the flat beam splitter element 440, as the linearly polarization-selective mirror element would only be selective to linearly (and not circularly) polarized light. The display device 500 instead includes the circularly polarization-selective beam-splitter element 540 in place of the flat beam splitter element 440. As light interacts with the circularly polarization-selective beam-splitter element 540 twice, the circularly polarization-selective beam-splitter element 540 is able to prevent a quarter of the light that would be lost in the display device 400 from being lost.

Panel B illustrates in greater detail light polarizations and throughput in the display device 500. As shown, light 515 emitted by the display 510 first passes through the linearly polarization-selective mirror element 520, which as discussed transmits one orientation of linearly polarized light, while reflecting the other orthogonal linear orientation. The one orientation of linearly polarized light that is transmitted by the polarization-selective mirror element 520 is 50% of the light 515 originally emitted by the display 510 (assuming the display 510 does not emit linearly polarized light). As shown, the linearly polarized light transmitted by the polarization-selective mirror element 520 passes through the quarter-wave plate element 530, which converts the linearly polarized light to circularly polarized light (e.g., right handed circularly polarized light). The circularly polarized light then reflects off of the circularly polarization-selective flat beam-splitter element 540, becoming orthogonally circularly polarized (e.g., left handed circularly polarized). As described, the circularly polarization-selective beam-splitter element 540 reflects one handedness of circularly polarized light while transmitting the other and also changes the handedness of the reflected light. It should be understood that, in the display device 500, the circularly polarization-selective mirror element 520 is disposed so as to reflect the handedness of circularly polarized light (e.g., right handed circularly polarized light) that the quarter-wave plate element 530 converts linearly polarized light into. As a result, essentially 100% of such circularly polarized light from the quarter-wave plate element 530 is reflected, with the opposite handedness, by the circularly polarization-selective beam-splitter element 540. The circularly polarized light reflected by the circularly polarization-selective beam-splitter element 540 passes back through the quarter-wave plate element 530, which converts the circularly polarized light back into linearly polarized light, but with an orthogonal polarization to the light previously transmitted by the linearly polarization-selective mirror element 520 (e.g., horizontal in this example). This linear polarization is oriented so that the light reflects off of the polarization-selective mirror element 520, which collimates the light and reflects the linearly polarized light with a 180 degree rotation. The collimated linearly (horizontally) polarized light reflected by the polarization-selective mirror element 520 passes through the quarter-wave plate element 530 again, which circularly polarizes the light, but with an opposite handedness to the circular polarization the first time the light passed through the quarter-wave plate element 530. The collimated circularly polarized light now has the proper circular polarization handedness (e.g., left-handed) to pass through the circularly polarization-selective beam-splitter element 540. As the light that passes through the circularly polarization-selective mirror beam-splitter element 540 is only of one handedness of circular polarization, a final circular polarizer element (e.g., circular polarizer element 450, which was used to sort undesired direct pass-through light from desired collimated folded light) is not required.

Although the display device 500 is shown as including a circularly polarization-selective flat beam-splitter element 540 which reflects light that is orthogonally circularly polarized, in an alternative embodiment, a chiral mirror element may be used for the flat beam splitter element. Chiral mirrors are also referred to as circularly polarization selective mirrors and are often a chiral (a twisted-shaped) liquid crystal or multilayer material, to interact with circularly polarized light. A chiral mirror preserves the handedness of polarization upon reflection (e.g., incident light that is right handed circularly polarized will reflect as right handed circularly polarized light), in contrast to other types of mirrors that invert the polarization 180° (converting right circularly polarized light into left circularly polarized light, and vice versa). A chiral mirror may be made using cholesteric liquid crystal or using metamaterials of microattenas arranged in rosette structures, asymmetric split rings, or layered twisted microstructures to interact with the circularly polarized light.

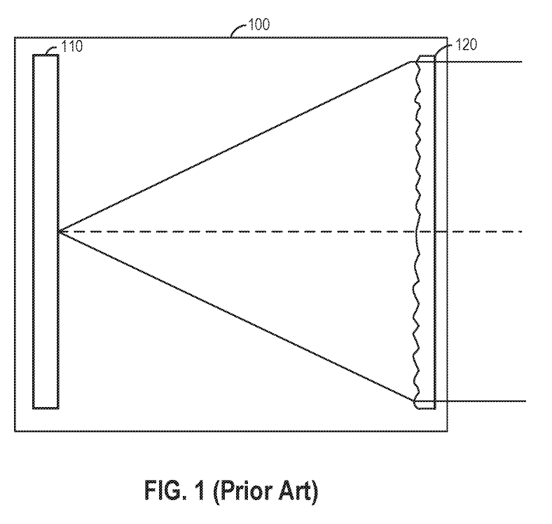

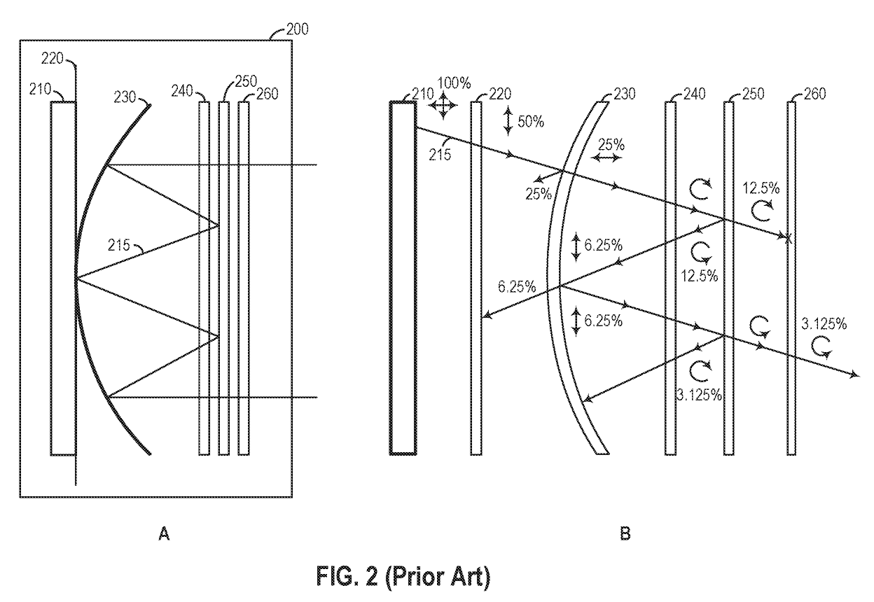

FIG. 6 illustrates a display device 600 with modified pancake optics, according to a third embodiment. As shown, the display device 600 includes a display 610 and an arrangement of optical elements including a flat linearly polarization-selective mirror element 620, a quarter-wave plate element 630, a flat beam splitter element 640, a lens element 650, and a circular polarizer element 660. The display 610, the polarization-selective mirror element 620, the quarter-wave plate element 630, the flat beam splitter element 640, and the circular polarizer element 660 are similar to the display 410, the polarization-selective mirror element 420, the quarter-wave plate element 430, the flat beam splitter element 440, and the circular polarizer element 450, respectively, of the display device 400 discussed above, and will not be described in detail herein for conciseness. In particular, the polarization-selective mirror element 620, the quarter-wave plate element 630, the flat beam splitter element 640, and the circular polarizer element 660 may each be achromatic, and the quarter-wave plate element 630 and the circular polarizer element 660 may further be AR-coated. The optical arrangement of the display device 600 differs from that of the display device 400 in that the concave (linear) polarization-selective beam-splitter mirror element 420 (which may also just be a beam-splitter mirror such as that shown in FIG. 1) is replaced with a flat linearly polarization-selective beam splitter element 620, which like the polarization-selective beam-splitter mirror element 420 may be achromatic. As a concave mirror element is not present to collimate light in the display device 600, the display device 600 includes an additional lens element 650 which is a refractive (as opposed to reflective) optic used to collimate the light. It should be understood that light emitted by the display 610 passes three times through the optical arrangement of the display device 600 before being collimated by the lens element 650. As a result, the depth of the display device 600 may be reduced by two-thirds compared to the simple magnifier device, rather than one-half in the case of the display devices 400-500 discussed above.

Although a single lens element 650 is shown for illustrative purposes, some embodiments may employ multiple optical elements to collimate light. For example, face-to-face Fresnel lenses (Plossl eyepiece), Fresnel with meniscus lenses, spherical lenses, achromatic lenses, gradient index lenses, holographic lenses, other refractive and diffractive optics, and/or other eyepiece designs may be used to collimate the light. Increasing the number of optical elements also increases the design degrees of freedom, helping to reduce aberrations. For example, if the required optical power is broken up into two elements from one, surface curvatures at each refracting surface decreases, reducing ray aberrations. Adding optical elements also allows adjusting of spacing, thickness, and index of refraction to further reduce aberrations. In addition, the optical arrangement including a flat (as opposed to concave) beam-splitter element and one or more optical elements that collimate light is also compatible with, and may be used in, other eyepieces, head-mounted displays, and general optical systems to reduce the physical path length of the system. Alternatively, such an optical arrangement may be used to keep the physical path length the same, but decrease the effective focal length of the system and thereby increase the eye box of the system for the same system thickness.

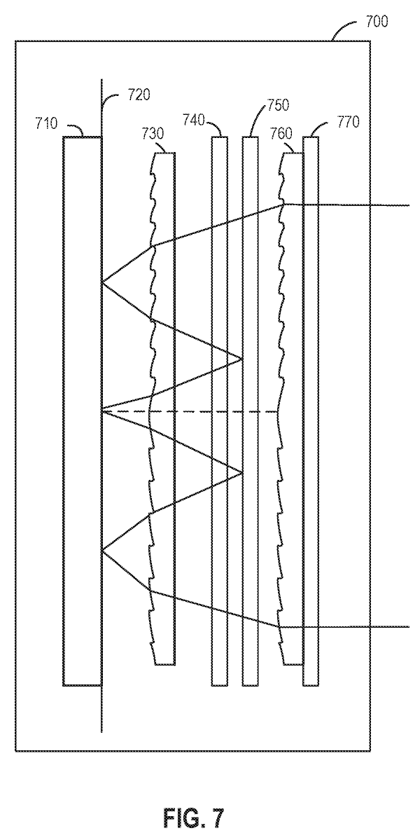

FIG. 7 illustrates a display device 700 with modified pancake optics, according to a fourth embodiment. As shown, the display device 700 includes a display 710 and an arrangement of optical elements including a linearly polarization-selective mirror element 720, a lens element 730, a quarter-wave plate element 740, a flat beam splitter element 750, another lens element 760, and a circular polarizer element 770. The display 710, the polarization-selective mirror element 720, the quarter-wave plate element 740, the flat beam splitter element 750, the lens element 760, and the circular polarizer element 770 are similar to the display 610, the polarization-selective mirror element 620, the quarter-wave plate element 630, the flat beam splitter element 640, the lens element 650, and the circular polarizer element 660, respectively, of the display device 600 discussed above, and will not be described in detail herein for conciseness. In particular, the polarization-selective mirror element 720, the quarter-wave plate element 740, the flat beam splitter element 750, and the circular polarizer element 770 may each be achromatic, and the quarter-wave plate element 740 and the circular polarizer element 770 may further be AR-coated. The optical arrangement of the display device 700 differs from that of the display device 600 in that the lens element 730 has been added to the optical arrangement in the display device 700. Although a single lens element 730 is shown for illustrative purposes, it should be understood that, in general, one or multiple lenses may be added to the optical arrangement stack between the polarization-selective mirror element 720 and the quarter-wave plate element 740. The single lens element 730 or multiple lenses may be face-to-face Fresnel lenses (Plossl eyepiece), Fresnel with meniscus lenses, spherical lenses, achromatic lenses, gradient index lenses, holographic lenses, other refractive and diffractive optics, and/or other eyepiece designs.

The lens element 730 (or multiple lens elements) operates in conjunction with the lens element 760 to collimate light, with their optical powers adding together to equal the power of the single lens element 650. By splitting the collimating power between multiple surfaces, optical performance can be improved, including the reduction of aberrations. Alternatively, multiple lenses may be used with the same power as before to reduce the thickness of the optical arrangement (and the display device 700) to approximately a quarter of the thickness of the pancake optics arrangement of the display device 400. That is, the optical arrangement can be shortened, and/or kept at the same thickness with a reduction in aberrations. By placing one or more lenses, such as the lens element 730, within the optical arrangement stack, light emitted by the display 710 will pass through such internal lens(es) three times before exiting the display device 700, which multiplies the focal power of the lens(es). In some embodiments, the lens(es) may be either glass or low-birefringent plastic to avoid disrupting the polarization of the light within the stack critical for proper behavior of the optical arrangement. Although described herein primarily with respect to lenses, such as the lens element 730, that are flat, alternatively (or in combination), multiple concave lenses may be used in the optical arrangement stack in other embodiments to make the modified pancake optics (and systems based on it) thinner.

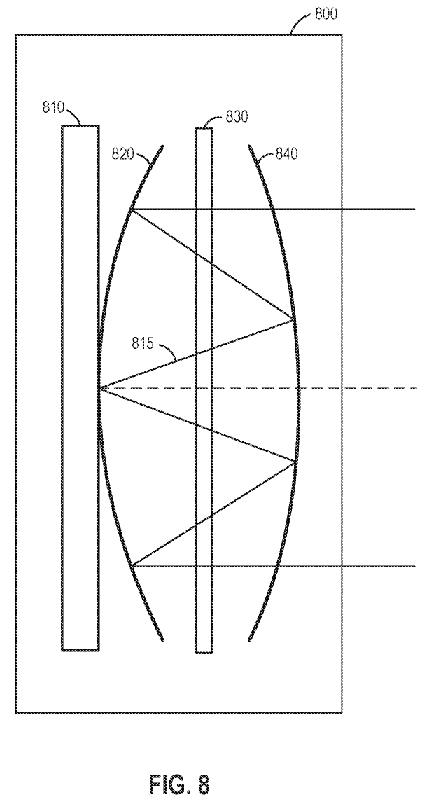

FIG. 8 illustrates a display device 800 with modified pancake optics, according to a fifth embodiment. As shown, the display device 800 includes a display 810 and an arrangement of optical elements including a linearly polarization-selective mirror element 820, a quarter-wave plate element 830, and a circularly polarization-selective mirror element 840. The display 810 and the quarter-wave plate element 830 are similar to the display 510 and the quarter-wave plate element 530, respectively, of the display device 500, discussed above, and will not be described in detail herein for conciseness. In particular, the quarter-wave plate element 830 may be achromatic and AR-coated. The optical arrangement of the display device 800 differs from that of the display device 500 in that the circularly polarization-selective mirror element 840, which may be achromatic, is curved, and the curved linearly polarization-selective mirror beam splitter element 820, which may also be achromatic, and the curved circularly polarization-selective mirror beam splitter element 840 are in a “clamshell” configuration. That is, both the linearly polarization-selective mirror beam splitter element 820 and the circularly polarization-selective mirror beam splitter element 840 are curved, rather than both beam splitters being flat or one of the beam splitters being curved while the other is flat. Use of the two curved beam splitter elements 820 and 840 splits the collimating power between two surfaces, which as discussed may improve optical performance by reducing aberrations. In addition, as opposing facing concave mirrors have a longer radius of curvature than a single mirror and it tends to be relatively easier to laminate optics with longer radiuses of curvature, the curved beam splitter elements 820 and 840 may be relatively easier/cheaper to laminate than a single curved beam splitter. In other embodiments, rather than the linearly and circularly polarization-selective beam splitter elements being flat or curved, the edges of those beam splitters may be of any feasible shape. In yet further embodiments, one or both of the linearly and circularly polarization-selective beam splitter elements may include a membrane surface that also reduces aberrations.

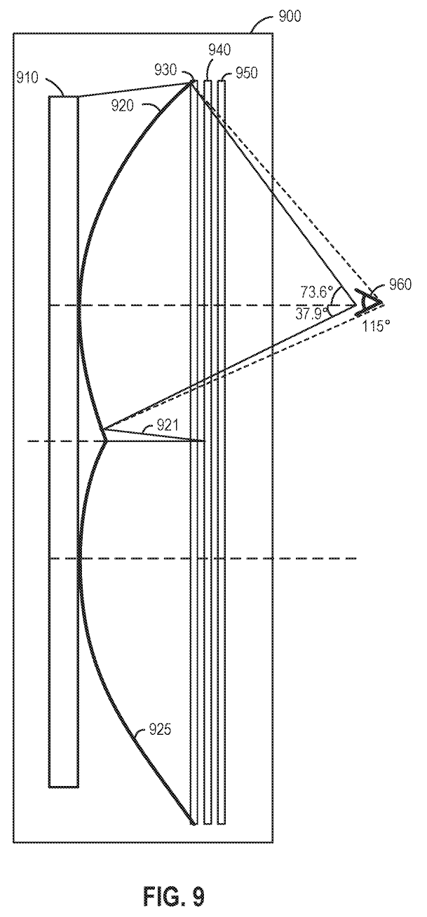

FIG. 9 illustrates a display device 900 with modified pancake optics, according to a sixth embodiment. As shown, the display device 900 includes a display 910 and an arrangement of optical elements including linearly polarization-selective mirror beam splitter elements 920 and 925, a quarter-wave plate element 930, a flat 50/50 (half-silvered) beam splitter element 940, and a circular polarizer element 950. The display 910, the quarter-wave plate element 930, the flat beam splitter element 940, and the circular polarizer element 950 are similar to the display 410, the quarter-wave plate element 430, the flat beam splitter element 440, and the circular polarizer element 450, discussed above, and will not be described in detail herein for conciseness. In particular, the quarter-wave plate element 930, the flat beam splitter element 940, and the circular polarizer element 950 may each be achromatic, and the quarter-wave plate element 930 and the circular polarizer element 950 may further be AR-coated. The polarization-selective beam splitter mirror elements 920 and 925, which also be achromatic, differ from the polarization-selective beam splitter mirror element 420 in that the polarization-selective beam splitter mirror elements 920 and 925 are concave mirrors whose depths are equal to the entire optical arrangement. As used herein, a spherical concave mirror's depth, which is also sometimes referred to as its “sag,” is the difference between an apex and an edge of the mirror. As shown, the polarization-selective beam splitter mirror elements 920 and 925 fill the entire gap between the display 910 and the flat optics (namely, the quarter-wave plate element 930, the flat beam splitter element 940, and the circular polarizer element 950). Use of such polarization-selective beam splitter mirror elements 920 and 925 helps maximize the field of view, thereby providing a wide field of view and immersive experience to the user. Illustratively, a nasal side 921 of the concave mirror element 920 fills the entire optical arrangement, as the nasal side 921 needs to abut the polarization-selective mirror element 925 from the other eye's stack of optical elements. In a particular embodiment, the polarization-selective beam splitter mirror elements 920 and 925 may have approximately 2″ focal lengths (8″ diameters), a 1″ sag and depth of the optical arrangement, with 2.67″ between the mirror centers. Such a design has a 37.9° nasal field of view, and 73.6° temporal flow per eye (or 147.2° field of view with 75.8° overlap for two eyes).

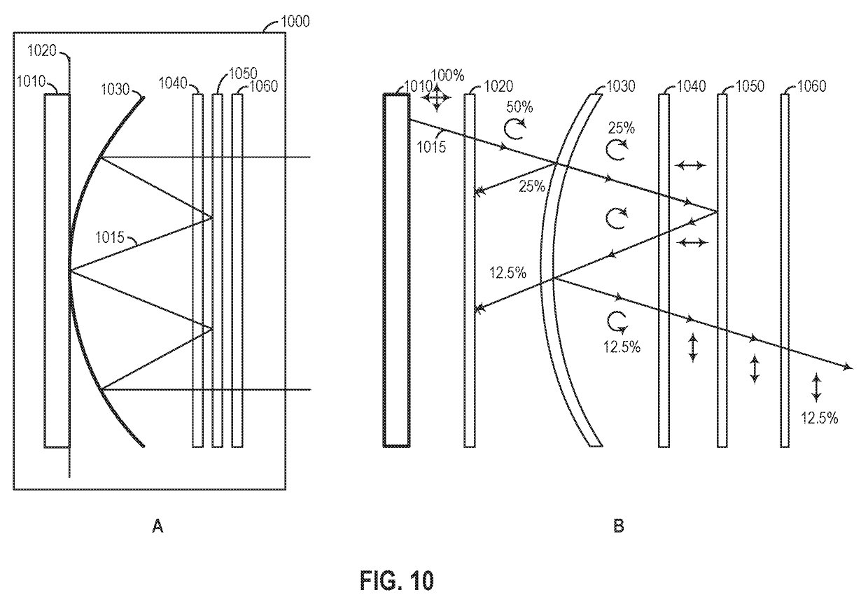

FIG. 10 illustrates a display device 1000 with modified pancake optics, according to a seventh embodiment. As shown in panel A, the display device 1000 includes a display 1010 and an arrangement of optical elements including a circular polarizer element 1020, a concave 50-50 (half-silvered) beam-splitter element 1030, a quarter-wave plate element 1040, a flat polarization-selective mirror element 1050, and a linear polarizer element 1060. The display 1000 is similar to the display 410 of the display device 400, discussed above, and will not be described in detail herein for conciseness. As described with respect to FIG. 4, pancake collimating optics are used to decrease the depth of the device 400, and a linearly polarization selective mirror element 420 may be used to increase optical efficiency (brightness). However, the linearly polarization selective collimating mirror element 420 is curved, which typically requires planar sheets of polarization selective mirror material to be shaped into a compound curve surface, such as a spherical surface. In particular, vacuum forming and injection molding are typically required to heat and stretch the polarization selective mirror material to make a planar sheet conform to a sphere, with such stretching and heating often altering or destroying the polarization selective properties of the material unless temperature and timing are carefully controlled in manufacturing. Compound curved surfaces with deep sags or short diameters may also be difficult to form from flat polarization selective sheets, and the process of forming curved linearly polarization selective collimating mirrors can be expensive. In the display device 1000, the ordering of the optical elements is “flipped,” with light entering the optical arrangement linearly polarized and leaving circularly polarized. This flipped optical arrangement avoids the need for the curved polarization selective mirror element 420, which is instead replaced with the concave 50/50 beam-splitter (half-silvered) mirror element 1030. At the same time, the flat half-silvered beam-splitter element 440 is replaced with the flat polarization-selective mirror element 1050. As a result, the “flipped” pancake optical arrange is relatively easier to manufacture, as the optical arrangement uses the flat polarization-selective mirror element 1050 that does not need to be molded into a compound shape, and half-silvering the collimating curved mirror can easily be achieved using metal deposition. As polarization selective optics are used, the “flipped” pancake optical arrangement is also four times brighter than the traditional pancake optical arrangement using only half-silvered mirrors for both the curved mirror and the final flat beam splitter. In addition, the “flipped” pancake optical arrangement reduces the depth of the optical arrangement by approximately half of the unfolded optical arrangement of the display device 100, and larger fields of view may be relatively easier to achieve using the “flipped” pancake optical arrangement's mirror element 1050 than with the Fresnel lens of the optical arrangement in the display device 600 described above. In the “flipped” pancake optical arrangement, the circular polarizer element 1020, the concave 50-50 (half-silvered) beam-splitter element 1030, the quarter-wave plate element 1040, the flat polarization-selective mirror element 1050, and the linear polarizer element 1060 may each be achromatic, and the circular polarizer element 1020 and the quarter-wave plate element 1040 may further be AR-coated. Similar to the discussion above, the AR coating of the circular polarizer element 1020 and the quarter-wave plate element 1040 is to prevent stray reflections so that the only reflections are at the mirrors (the polarization-selective mirror element 1050 and the 50-50 (half-silvered) beam-splitter element 1030 in the display device 1000). For example, light passing back through the 50-50 (half-silvered) beam-splitter element 1030 should not reflect off the circular polarizer's surface (leading to stray reflections back through the system), but rather be absorbed by the circular polarizer (which may include a stacked quarter wave plate and a linear polarizer).

As shown in panel B, light emitted by the display 1010 passes through the circular polarizer element 1020 to become right-handed circularly polarized (but could be left-handed circularly polarized in an alternative embodiment). The circularly polarized light then passes through the half-silvered curved beam splitter element 1030, with half of the light being reflected back as left-handed polarized light that is absorbed by the circular polarizer element 1020. The circularly polarized light that is transmitted by the circular polarizer element 1020 continues and passes through the quarter-wave plate element 1040, which linearly polarizes the light and outputs what is shown as vertically polarized light. The vertically polarized light reflects off of the flat polarization selective mirror element 1050, which is oriented to reflect such vertically polarized light and transmit horizontally polarized light. The reflected vertically polarized light passes again through the quarter-wave plate element 1040 to become left circularly polarized. The left circularly polarized light is then incident on the half-silvered curved beam splitter element 1030, which reflects half of the light again, with the reflected light becoming right circularly polarized and collimated (with the folded path length being equal to the focal length of the half-silvered curved beam-splitter mirror element 1030). The right circularly polarized light that is reflected from the half-silvered curved beam splitter element 1030 passes through the quarter-wave plate element 1040, which linearly polarizes such light to become horizontally polarized light. The horizontally polarized light passes through the flat polarization selective mirror element 1050, and then through the horizontal linear polarizer element 1060, before exiting the display device 1000.

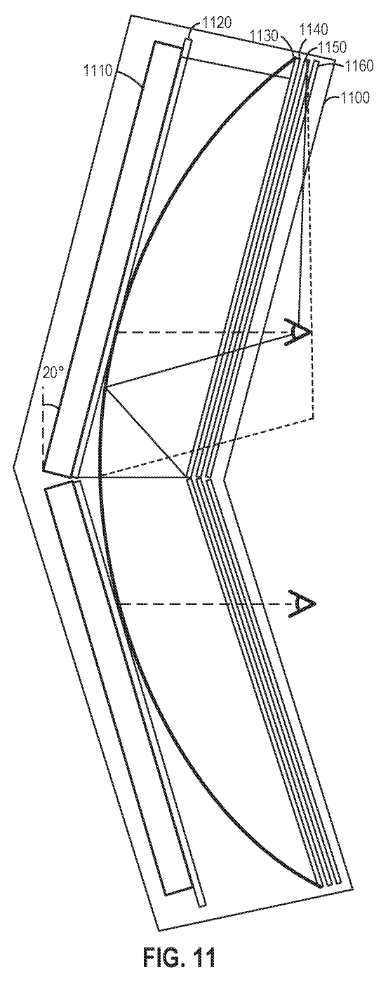

FIG. 11 illustrates a display device 1100 with modified pancake optics, according to an eighth embodiment. As shown, the display device 1100 includes a display 1110 and an arrangement of optical elements including a circular polarizer element 1120, a concave 50-50 (half-silvered) beam-splitter mirror element 1130, a quarter-wave plate element 1140, a flat polarization-selective mirror element 1150, and a linear polarizer element 1160. The display 1110 is similar to the display 1010, discussed above, and will not be described in detail herein for conciseness. In addition, the circular polarizer element 1120, the half-silvered curved beam-splitter element 1130, the quarter-wave plate element 1140, the flat polarization-selective mirror element 1150, and the linear polarizer element 1160 are in the same order as and work in substantially the same way as the circular polarizer element 1020, the half-silvered curved beam-splitter element 1030, the quarter-wave plate element 1040, the flat polarization-selective mirror element 1050, and the linear polarizer element 1060, respectively, in the “flipped” pancake optical arrangement discussed above with respect to FIG. 10, except these optical elements are canted. As shown, the cant is a 20° cant. It should be understood that canting rotates the left and right eye display and optical arrangement assemblies away from each other (on their optical axes) so that there is a partial overlap, as opposed to a complete overlap, between the fields of view of a user's left and right eyes. Experience has shown that an overlap of between 30° and 40° is sufficient for stereo vision, so canting can be used to produce such an overlap while increasing the lateral field of view by rotating the field of view of the right eye to the right and the field of view of the left eye to the left. As a result, the canting of the display 1100 and optical arrangement in the display device 1100 may provide a wider field of view than the uncanted display 1010 and optical arrangement in the display device 1000.

In another embodiment, the display device 1100 may include a prism film (not shown) to shift viewpoint temporally (or views nasally), thereby increasing stereo overlap. For example, if large f/# lenses are used rather than common small f/# lenses, then an eyebox size may be increased but a magnification, nasal field of view, and amount of stereo-overlap may be decreased. In such a case, the display device 1100's nasal field of view may be less than the eye's 60° nasal field of view, such that objects in the periphery are outside the stereo region, the nose piece may be visible, and the sense of immersion reduced. By adding a prism film (or alternatively, a shifted off-axis eyepiece), the view point may be shifted or rotated, so the eyes' nasal field of view is filled, there is nasal field of view and increased stereo overlap, the nose piece is not visible, and the sense of immersion increased. In one embodiment, the prism film may be added after the flat polarization-selective mirror element 1150 (or the circularly polarization-selective beam-splitter element 540 or the circular polarizer element 660 in FIGS. 5 and 6, respectively), such that the prism film is the last optical film (except perhaps a protective clear plate) before the eye. Alternatively, the final flat polarization-selective mirror element 1150 (or the circularly polarization-selective beam-splitter element 540 or the circular polarizer element 660 in FIGS. 5 and 6, respectively) may be shifted be off-axis in order to shift the field of view nasally.

In yet further embodiments, a display device may include an optical arrangement that permits the focal plane to be changed in real time based on where the display imagery is, thereby creating true optical depth, or the creation of a light field. In one embodiment, the display device may include multiple flat mirror elements (e.g., instead of the single flat beam splitter mirror element 440, the display device 400 may include multiple such mirror elements) with different spacings from a concave mirror element and able to be turned on and off (switching between completely transparent and completely or partially reflective) to produce two or more discreet conjugate focal planes. Other embodiments may include either a varifocal lens element; an acoustically coupled varifocal lens element; Fresnel mirrors including liquid crystal type reflector elements with different indices, creating a varifocal Fresnel mirror; etc. The focal planes may either be continuously movable or discreet focal planes that are switched between. For example, when a character in a VR environment is close to the user, the focal depth may be changed to 5 feet, while the focal depth then be changed to 10 feet or infinity when the character moves farther away. This may be achieved by taking an opposite of the z buffer, mapping the opposite of the z buffer onto different focal planes, and multiplexing. Changing focal planes solves the problem that stereo imaging at finite focal plane(s) can result in a dissociation of convergence and focus, in which the eye wants to focus where the focal plane is but simultaneously converge where an image that is not at the same depth is. Dissociation of convergence and focus can cause eye strain and make a displayed image look unrealistic. Dynamically adjusting the focal plane may counteract these effects to reduce eye strain and increase realism. Rather than refocusing the depth, multiple optical elements such as the flat mirror elements, varifocal lens element, etc. described above may be used to create a light field type display in other embodiments. For example, assuming there are four (or other number of) focal planes, the pixels of a displayed imagery may be broken up into four (or other number of) zones based on the z buffer and mapped onto focal planes so that the pixels are only displayed their z buffer depth, with multiplexing between the displayed pixels. Doing so essentially images pixels at different depths, creating a light field.

Advantageously, embodiments disclosed herein provide AR/VR display devices that are brighter than display devices with traditional pancake optics and have a relatively small size and weight. In particular, the optical arrangements discussed herein may be employed in, e.g., AR/VR display devices which have constrained thicknesses and which are required (or desired) to produce a wide field of view and relatively bright images. For example, the optical arrangements described herein may be included in head-mounted displays, flight simulators, wall or car-mounted display devices, and multi-person display devices (e.g., a porthole in a submarine that includes a display), among other things. The optical arrangement in the display device 400, which includes the linearly polarization-selective mirror element 420, is approximately four times brighter than traditional pancake optics and approximately half as thick as the simple magnifier. The efficiency of such an optical arrangement not only produces brighter images but also allows displays with lower luminance, such as OLEDs, to be used. The optical arrangement in the display device 500, which includes the linearly polarization-selective mirror element 520 and the circularly polarization-selective beam-splitter element 540, may be essentially 100% efficiently with its light (or 50% efficient if the display is not pre-polarized), while also being approximately half as thick as the simple magnifier. The optical arrangement in the display device 600, which includes the flat linearly polarization-selective mirror element 620, permits the use of one or multiple refractive optic elements, such as the lens element 650, to reduce aberrations and also reduces the thickness of the optical arrangement by approximately two-thirds, while allowing the user to get closer to the collimating optic and potentially increasing the field of view and eyebox. This is in contrast to traditional pancake optics, which uses a single reflecting mirror element to collimate the light and does not permit display devices to be as thin (or as light) as the display device 600. The optical arrangement in the display device 700 allows multiple lenses, such as the lens element 730 or alternatively (or in combination) concave lens element(s) to be used, which may make the optical arrangement (and the display device 700) even thinner relative to the simple magnifier and traditional pancake optics. The optical arrangement in the display device 800 includes the linearly polarization-selective mirror beam splitter element 820 and the circularly polarization-selective mirror beam splitter element 840 that are both curved, which may increase optical performance, and curved beam splitter elements may also be relatively easier/cheaper to manufacture through lamination. The optical arrangement in the display device 900 includes the concave mirror element 920 (and 925) that fills the entire optical arrangement stack thickness, thereby producing a wider field of view. The optical arrangement in the display device 100 includes “flipped” pancake optics with a flat polarization-selective mirror element 1050, which is relatively easier to manufacturer using metal deposition than a curved polarization-selective mirror element such as that in the display device 400. Like the optical arrangement in the display device 400, the optical arrangement in the display device 1000 is approximately four times brighter than traditional pancake optics and approximately half as thick as the simple magnifier. In addition, relatively larger fields of view may be relatively easier to achieve with the “flipped” pancake optics mirror element 1050. The optical arrangement in the display device 1100 is canted, allowing for a wider field of view. A display device may also include an optical arrangement, such as one with multiple flat mirror elements that can be switched on and off with different spacings from a concave lens element, which permits a focal plane to be changed in real time based on where displayed imagery is or the creation of a light field.

In the preceding, reference is made to embodiments of the disclosure. However, the disclosure is not limited to specific described embodiments. Instead, any combination of the preceding features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the preceding aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special-purpose hardware-based systems that perform the specified functions or acts, or combinations of special purpose hardware and computer instructions.

Additional examples of storytelling devices and story management and creation techniques, as well as proximity detection techniques and communication protocols, are provided in the attached appendices.

While the foregoing is directed to embodiments of the present disclosure, other and further embodiments of the disclosure may be devised without departing from the basic scope thereof, and the scope thereof is determined by the claims that follow.

What is claimed is:

1. A display device, comprising:
a display configured to emit light; and
an optical arrangement including:
a first beam splitter mirror element, the first beam splitter mirror element being linearly polarization-selective and configured to transmit a portion of the emitted light as a first linearly polarized light,
a quarter-wave plate element configured to convert the first linearly polarized light into a first circularly polarized light, and
a second beam splitter mirror element configured to reflect, toward the quarter-wave plate element, a first portion of the first circularly polarized light, wherein:
the quarter-wave plate converts the reflected first portion of the first circularly polarized light into a second linearly polarized light,
the first beam splitter mirror element reflects, toward the quarter-wave plate element, the second linearly polarized light with a 180 degree rotation as a third linearly polarized light,
the quarter-wave plate element converts the third linearly polarized light into a second circularly polarized light, and
the second beam splitter mirror element transmits a portion of the second circularly polarized light.

2. The display device of claim 1, wherein the second beam splitter mirror element is a half-silvered mirror, the display device further comprising:
a circular polarizer element configured to extinguish a second portion of the first circularly polarized light that is transmitted by the second beam splitter mirror element and to transmit the portion of the second circularly polarized light transmitted by the second beam splitter mirror.

3. The display device of claim 2, wherein the first beam splitter mirror element, the quarter-wave plate element, and the circular polarizer element are achromatic.

4. The display device of claim 3, wherein the quarter-wave plate element and the circular polarizer element are achromatic are further anti-reflection coated.

5. The display device of claim 1, wherein:
the second beam splitter mirror element is circularly polarization-selective;
the reflected first portion of the first circularly polarized light includes substantially all of the first circularly polarized light; and
the transmitted portion of the second circularly polarized light includes substantially all of the second circularly polarized light.

6. The display device of claim 1, wherein the second beam splitter mirror element is a chiral mirror.

7. The display device of claim 1, wherein:
the first beam splitter mirror element is concave; and
the third linearly polarized light reflected by the first beam splitter mirror element is collimated.

8. The display device of claim 1, wherein the first beam splitter mirror element is flat, the display device further comprising:
a first lens element disposed between the second beam splitter mirror element and a circular polarizer element, the first lens element being configured to collimate the portion of the second circularly polarized light transmitted by the second beam splitter mirror element.

9. The display device of claim 1, wherein the first beam splitter mirror element is flat, the display device further comprising:
a first lens element disposed between the second beam splitter mirror element and a circular polarizer element; and
one or more other lens elements disposed between the first beam splitter mirror element and the quarter-wave plate element,
wherein the first lens element and the one or more other lens elements are configured to together generate collimated light.

10. The display device of claim 9, wherein the one or more other lens elements includes at least one of a face-to-face Fresnel lens, a Fresnel with meniscus lens, a spherical lens, an achromatic lens, a gradient index lens, a holographic lens, and other refractive and diffractive optics.

11. The display device of claim 1, wherein the first and second beam splitter mirror elements are both curved.

12. The display device of claim 1, wherein the first beam splitter mirror element is a tilted beam splitter or a conformal membrane beam splitter.

13. The display device of claim 1, wherein the first beam splitter mirror element is a concave mirror whose depth is equal to the entire optical arrangement.

14. The display device of claim 1, further comprising, one or more additional beam splitter mirror elements, each of the second beam splitter mirror element and the one or more additional beam splitter mirror elements being disposed at a different distance from the first beam splitter mirror element.

15. The display device of claim 1, further comprising, at least one of a varifocal lens, an acoustically coupled varifocal lens, and a varifocal Fresnel mirror.

16. The display device of claim 1, wherein the display device is one of a head-mounted display, a flight simulator, a wall-mounted display device, a vehicle-mounted display device, and a multi-person display device.

17. The display device of claim 1, wherein the display and the optical arrangement are canted to produce between a 30° and a 40° overlap between left and right eye fields of view.

18. The display device of claim 1, wherein the first beam splitter mirror element that is linearly polarization-selective conforms to a Poisson equation.

19. The display device of claim 1, wherein the quarter-wave plate element is a tilted spaced double-sided anti-reflection (AR)-coated quarter-wave plate.

20. A display device, comprising:
a display configured to emit light; and
an optical arrangement including:
a circular polarizer element configured to transmit a portion of the emitted light as a first circularly polarized light,
a concave first beam splitter mirror element configured to transmit a portion of the first circularly polarized light,
a quarter-wave plate element configured to convert the portion of the first circularly polarized light transmitted by the first beam splitter into a first linearly polarized light, and
a flat second beam splitter mirror element, the second beam splitter mirror element being linearly polarization-selective and configured to reflect, toward the quarter-wave plate element, the first linearly polarized light, wherein:
the reflected first linearly polarized light is converted by the quarter-wave plate into a second circularly polarized light,
the first beam splitter mirror element reflects, toward the quarter-wave plate element, the second circularly polarized light with an orthogonal polarization as a third circularly polarized light,
the quarter-wave plate element converts the third circularly polarized light into a second linearly polarized light, and
the second beam splitter mirror element transmits the second linearly polarized light.

21. The display device of claim 20, wherein a depth of the concave first beam splitter mirror element is equal to the entire optical arrangement.

22. The display device of claim 20, wherein the display and the optical arrangement are canted to produce between a 30° and a 40° overlap between left and right eye fields of view.

23. The display device of claim 20, further including at least one of a prism film and a shifted off-axis eyepiece.

24. A display device, comprising:
a display;
a linearly polarization-selective beam splitter mirror element;
a quarter-wave plate element; and
at least one of a half-silvered beam splitter mirror element and a circularly polarization-selective mirror element.

25. The display device of claim 24, wherein:
the linearly polarization-selective beam splitter mirror element is concave and disposed on a first side of the quarter-wave plate element;
the half-silvered beam splitter mirror element is disposed on a second side of the quarter-wave plate element; and
the first side is closer to the display than the second side.

26. The display device of claim 24, wherein:
the linearly polarization-selective beam splitter mirror element is disposed on a first side of the quarter-wave plate element;
the half-silvered beam splitter mirror element is concave and disposed on a second side of the quarter-wave plate element; and
the second side is closer to the display than the first side.

27. The display device of claim 24, further comprising, one or more lens elements configured to collimate light.
